(19) United States
(12) Patent Application Publication
(10) Pub. No.: US 2014/0011179 A1
(43) Pub. Date: Jan. 9, 2014

(54) METHODS AND SYSTEMS FOR PROVIDING EDUCATIONAL AND INSTRUCTIONAL PROGRAMS USING CELLULAR MEDIA

(71) Applicants: Diana Bertonazzi, Vineland, NJ (US); Robert Griffiths, Vineland, NJ (US)

(72) Inventors: Diana Bertonazzi, Vineland, NJ (US); Robert Griffiths, Vineland, NJ (US)

(21) Appl. No.: 13/541,849

(22) Filed: Jul. 5, 2012

(51) Int. Cl. G09B 7/00

(52) U.S. Cl. 434/353

(57) ABSTRACT

Methods and systems for providing educational and instructional programs to users through wireless and cellular technology is disclosed. The method is designed to be highly flexible to allow the user a broad range of course selections, instruction difficulty level, and format of the instruction provided to the user. In a preferred embodiment of the method, the core steps comprise (a) authorizing the subscriber information; (b) identifying the selected curriculum, grade level, and format for the requested instruction; (c) selecting an appropriate question; (d) transmitting the selected question to the subscriber's cellular device; (e) receiving the subscriber's answer to the transmitted question; (f) determining whether the subscriber's answer is correct; (g) advising the subscriber whether the transmitted answer was correct; (h) recording and tracking the subscriber's answers in a database and then repeating the selecting process, and updating and analyzing the subscriber's progress.

### FIELD OF THE INVENTION

The present invention relates to education, instruction, and training methods and systems. More particularly, the disclosed invention relates to methods and systems for providing educational and instructional programs using cellular technology as a core medium of transmission of the programs and information. In one preferred embodiment, the method of instruction can be used to provide subscribers with access to instructional and educational data that may be self-paced according to the subscriber's desires, or may allow real-time connection to a instructional tutor.

### BACKGROUND OF THE INVENTION

There is no questioning of the fact that information dissemination has moved into electronic media, and more specifically to wireless electronic media. Access of the public to news, updates, direct communications, and other relevant, and sometimes irrelevant, information will soon be primarily through wireless media. Not only are most people becoming more mobile, but they are expecting to have access to all types of information while they are “on the move.”

As people become more accustomed to accessing all types of information through cellular phones, BlackBerry® type devices, and wireless computer or laptop connections, they will be expecting and looking to obtain other types of information through such wireless media. For example, for many years, indeed for centuries, news information has been published and distributed through newspapers that people would read throughout the day. Over the past five to ten years, news information and publication has moved to being “published” through wireless devices including BlackBerry® devices and cell phones.

Given the mobility of many people in today's society, people should be able to use their available free time, no matter where they may be located, for accessing all types of information, including instructional or educational materials. However, there does not appear to be any systems or methods for providing such educational programs over a wireless or cellular media that has been widely accepted. If such a system were developed and available, people would be able to obtain educational or instructional training on cell phones at their own schedule, instead of needing to be located at a particular institution or facility. Thereby travel and time constraints could be substantially reduced and people would still be able to receive educational training at their own desired pace and specified level, and within their own time limitations.

### SUMMARY OF THE INVENTION

The above noted problems, which are inadequately or incompletely resolved by the prior art are completely addressed and resolved by the present invention.

A preferred aspect of the present invention is a method for providing educational and instructional programs to subscribers through said subscribers' cellular devices, comprising the steps of selecting an instructional question to be transmitted to a subscriber's cellular device; transmitting the selected instructional question to the subscriber's cellular device; receiving from the subscriber's cellular device a response to the selected instructional question; determining whether the subscriber's response correctly answered the selected instructional question; analyzing the subscriber's response and providing feedback to the subscriber based upon said analysis of the subscriber's response.

Another preferred aspect of the present invention is a method for providing educational and instructional programs to subscribers through said subscribers' cellular devices, comprising the steps of (a) identifying a subscriber's cellular device for receipt of educational and instructional data; (b) authorizing the subscriber's request for access to an instructional program; (c) providing to the subscriber's cellular device a selection of instructional programs; (d) providing to the subscriber's cellular device a selection of instructional levels; (e) providing to the subscriber's cellular device a selection of instructional formats; (f) receiving from the subscriber a selected instructional program, instructional level, and instructional format; (g) selecting an instructional question based upon the selected instructional program, instructional level, and instructional format; (h) transmitting the selected instructional question to the subscriber's cellular device; (i) receiving from the subscriber's cellular device an answer to the selected instructional question; (j) determining whether the subscriber's answer is a correct answer to the selected instructional question; (k) providing feedback to the subscriber based upon the determination of whether the subscriber's answer was a correct answer; and (l) recording the subscriber's answer to the selected instructional question in a database.

A further preferred aspect of the present invention is a system for providing educational and instructional curricula to subscribers using cellular communications, comprising one or more servers in communication with a global telecommunications network; a database maintained within the one or more servers; a plurality of subscribers' cellular devices in communication with the telecommunications network that is in communication with the one or more servers; wherein the one or more servers operate a computer software program that sequences at least the following steps: (a) selecting an instructional question from the database to be transmitted to a subscriber's cellular device; (b) transmitting the selected instructional question over the global telecommunications network to one or more subscriber's cellular device; (c) receiving from one or more of the subscriber's cellular device a response to the selected instructional question; (d) determining whether the subscriber's response correctly answered the selected instructional question; (e) analyzing the subscriber's response and providing feedback to the subscriber based upon said analysis of the subscriber's response.

Still another preferred aspect of the present invention is a method for providing educational and instructional programs to subscribers through said subscribers' wireless devices, comprising the steps of: (a) selecting an instructional question to be transmitted to a subscriber's wireless device; (b) transmitting the selected instructional question to the subscriber's wireless device; (c) receiving from the subscriber's wireless device a response to the selected instructional question; (d) determining whether the subscriber's response correctly answered the selected instructional question; (e) analyzing the subscriber's response and providing feedback to the subscriber based upon said analysis of the subscriber's response.

The invention will be best understood by reading the following detailed description of the several disclosed embodiments in conjunction with the attached drawings that briefly described below.

### BRIEF DESCRIPTION OF THE DRAWINGS

The invention is best understood from the following detailed description when read in connection with the accompanying drawings. It is emphasized that, according to common practice, the various features of the several drawings are not to scale, and the invention is not limited to the precise arrangement as may be shown in the accompanying drawings. On the contrary, the ordering and locations of the various features and steps are arbitrarily expanded or reduced for clarity, unless specifically noted in the attached claims.

FIG. 1: is an overview illustration showing a preferred embodiment of the wireless education system primary elements of system servers and subscribers' wireless devices, and the interconnection between those servers and devices;

FIG. 2: is a flowchart showing a preferred embodiment of the wireless education system and interconnected levels of operation including subscriber identification, subscriber education, and subscriber reporting;

FIG. 3: is a further detailed flowchart showing a preferred embodiment of example steps which may be taken to identify the subscriber and for the subscriber to identify the topic or area for education or training;

FIG. 4: is a further detailed flowchart showing a preferred embodiment of example feedback steps which may be taken as between the system servers and subscriber to inter-communicate questions, responses and information within the identified topic or area for education or training; and

FIG. 5: is a further detailed flowchart showing a preferred embodiment of example steps which may be taken to record and report the subscribers' usage and responses provided as part of the inter-communication between the subscriber and the system servers.

### DESCRIPTION OF THE INVENTION

The present invention is method and system for providing instructional and/or educational communications to a plurality of subscribers through the subscribers' cellular or wireless devices. The system comprises as core elements one or more computer servers in communication with a global telecommunications network, and a plurality of subscribers' cellular devices that are similarly in communication with the same global telecommunications network. The communication between the computer servers and the subscribers' cellular devices is intended to be on a real-time basis.

Among other features and elements, the computer servers are designed to maintain a database of instructional questions, a database of subscribers, along with RAM to maintain data about the subscribers' history of instructional and educational communications. Moreover the servers operate the system software that inputs and maintains subscriber information, maintains the pool of databases of educational questions to be presented to the subscribers, records for each subscriber their respective and specific activity and usage of the educational system, records each subscribers' responses provided to the educational questions posed, and provides summary reports for each subscriber to identify the subscribers' usage of the system, accuracy of the subscribers' responses to the educational questions posed, and provides suggested areas of improvement for further education and training.

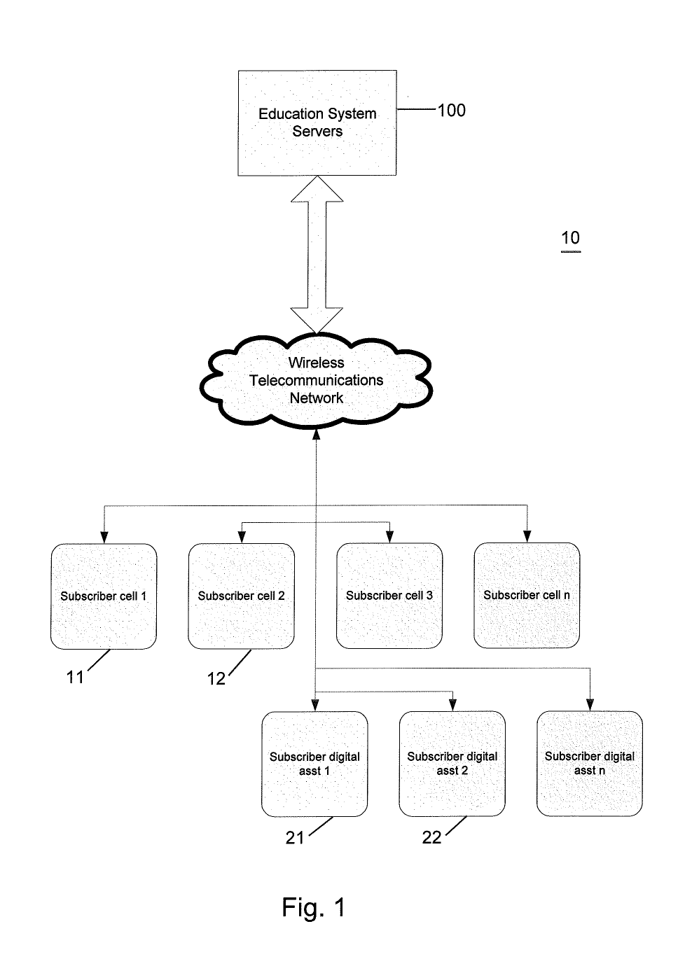

At a top level, the wireless educational system 10, as shown in FIG. 1, has at least one computer server 100 that is in two-way communication with a plurality of cellular devices 11, 12, and/or with a plurality of Blackberry® type devices 21, 22. While one server may be able to effectively communicate with a multitude of cellular devices, and maintain necessary subscriber and usage information about each of the users, for scaling purposes, as the number of users and subscribers increases, the server capability, or number of servers 100, should similarly and proportionally increase with the number of users in order to ensure effective operation of the system.

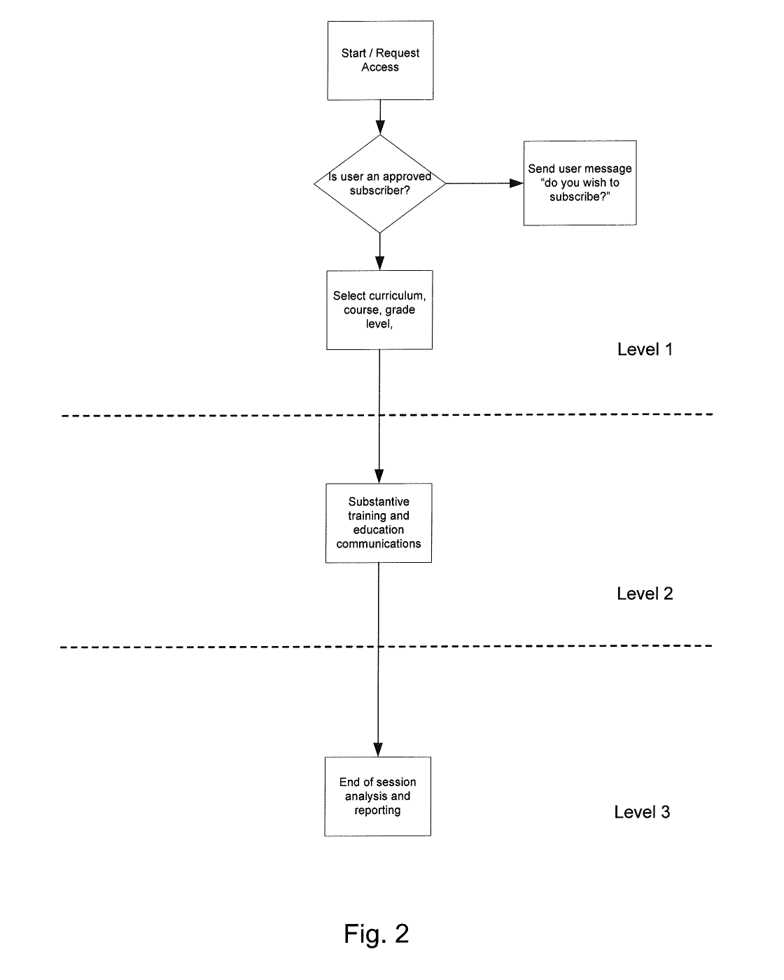

The basic flow of the wireless educational system, as shown in FIG. 2, is best illustrated as three levels of interconnected operation. The first level of the system and method of operation includes the user accessing the system, becoming a subscriber, and selecting the educational training desired. The second level is the substantive feedback educational training in which the subscriber interacts with the system servers on a real-time basis to be presented with (a) questions or information from within the pool of questions and information selected by the subscriber, and (b) feedback relating to the responses provided by the subscriber in response to the questions or information transmitted by the system servers, and also includes the recording of the subscribers' usage information and the subscribers' response or accuracy records. The third level of the inventive system and method includes the background analysis completed by the system, relating to the subscribers' responses and usage records, and the creation of reports to present the subscribers' records to a cell device or to a computer terminal.

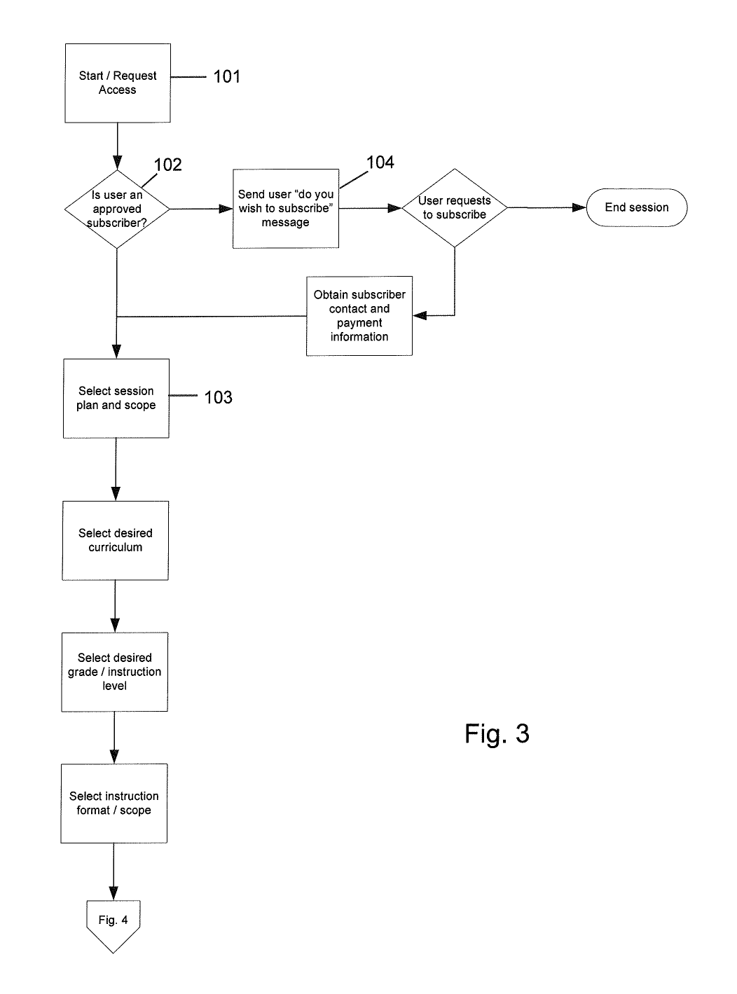

In further detail of the first level, and in a preferred embodiment as shown in FIG. 3, a user attempts to access 101 the system to obtain educational instruction or other information. The system 102 checks the user's identification information to determine whether the user is an approved subscriber. If the user is an approved subscriber, then the system allows the subscriber to have access to the substantive education program and transmits a request 103 for the subscriber to select the desired type and level of educational information. If the user is not an approved subscriber, then the system does not allow the user to have access to the substantive education program, and transmits a request 104 for the user to apply for admission as an approved subscriber.

After the subscriber has been approved for access to the system for educational instruction, the subscriber may now communicate in real-time with the system servers to receive and reply to educational or training questions and information. As illustrated in FIG. 3, the system presents a series of questions to the subscriber so that the subscriber may select (a) the plan or type of instruction to receive, (b) the type of educational curriculum from which to receive questions, as well as (c) the grade level or specific area of education. In preferred embodiments, the type of education can be standard core classes, such as English, arithmetic, mathematics, science, foreign languages, or other similar specific classes. The grade level selection to be made by the subscriber could be to decide within any of the particular classes, e.g., English, arithmetic, mathematics, or science, or whether the subscriber wishes to receive questions for a specific grade level or a range of grade levels. Only by way of example, the grade level could be, within the United States educational system, grades such as First, Second, Third, Fourth Grade and so on, or alternatively the range of grade levels could be elementary grades (e.g., First through Fifth Grade), middle school grades (e.g., Sixth through Eighth Grade), or high school (e.g., Ninth through Twelfth Grade), or college level instruction.

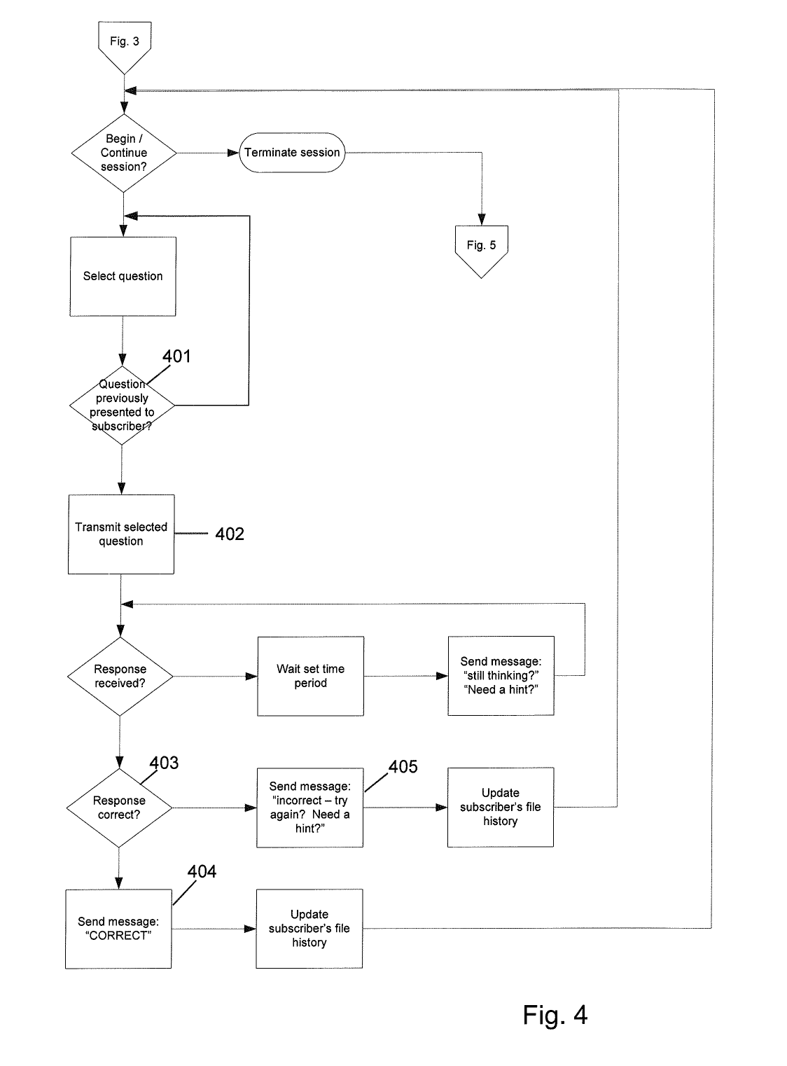

After the subscriber identifies and selects the topic area and type of instruction he or she wishes to receive, the system selects a question from within the database pool of potential questions, to be transmitted to the subscriber's cellular device. As shown in FIG. 4, the system checks 401 to see if that selected question has previously been posed or transmitted to the subscriber and whether the subscriber has previously answered the question correctly. If the subscriber has previously received the selected question, and answered the question correctly, then the system selects a different question from within the database of potential questions. Once the system has selected a question that has not been previously presented to the subscriber, and not previously answered correctly, then the system transmits 402 that question to the subscriber's cellular device.

Once received, the subscriber has a set time period within which to select and transmit a response to the posed question. Upon selection and transmission by the subscriber of a response or answer to the question posed by the system, the system checks 403 to see whether the response selected by the user is correct or incorrect. If the answer or response transmitted by the subscriber is correct, the system records that correct response for the selected question, and then transmits 404 a “correct” message to the subscriber, along with a question whether the subscriber wishes to continue. If the subscriber wishes to continue, the system repeats the above process and selects another question from within the database of potential questions and transmits that next question to the subscriber.

If the answer or response transmitted by the subscriber is not correct, the system records that the response for the selected question was not correct, and transmits an “incorrect” message to the subscriber. The system can also, in a preferred embodiment, transmit 405 a question to the subscriber requesting whether the subscriber wishes to select a different response, or whether the subscriber wishes a hint, or further information to assist the subscriber. In this manner, the subscriber is not only able to test his or her ability to understand the question and provide a correct response, but also may receive further education relating to the specific question or topic area.

The above process of receiving education questions, selecting a response to the question posed, and receiving further questions may be repeated by the subscriber so long as the time period or number of questions allowed for the subscriber have not been exceeded. If either the time period or number of questions are exceeded during an interactive session, the system can send a request to the subscriber asking whether the subscriber wishes to purchase more time, or further questions and education under the subscriber's approved plan.

In another embodiment of the present invention, the subscriber could be on a set plan or schedule to receive a predetermined number of questions. For example, the subscriber could have purchased a plan to receive three, four, five questions, or any number of desired questions in a single session. Under such a process, the subscriber would communicate with the system to receive a question posed, respond to the question, and then repeat that process for the number of questions provided under the particular plan purchased by the subscriber.

As described, the design of the education system is for the subscriber to have real-time feedback regarding education information and real-time feedback from the system as to questions presented and responses selected. Accordingly, the subscriber is provided with immediate feedback whether the response provided by the user was correct or incorrect, and thus is provided with feedback about how the subscriber is doing in that particular subject area. In a further preferred embodiment, the system could provide questions that require a short answer, or short response format, which would be reviewed at a later time, and thus would not provide immediate feedback to the user.

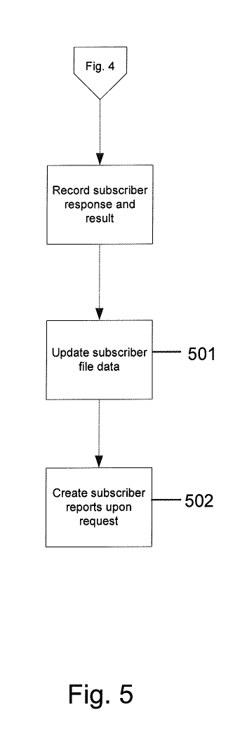

After the subscriber has decided to end the education session, he or she sends a response to the system to end that particular session. As illustrated in FIG. 5, the system then records 501 all data and information relating to that session within the subscriber's data file, including the number of questions posed, all of the specific questions posed, and whether the subscriber provided correct responses to the questions posed. The system also generates 502 one or more summary reports for the subscriber providing details about the subscriber's last education session, the subscriber's full records as to all curriculum or areas interacted with, as well as recommendations for future areas of education or instruction. The reports may be transmitted directly to the subscriber's cellular device or may be transmitted off-line to a computer, or alternatively, may be accessed and downloaded by the subscriber at a later time.

By way of example, and in a preferred embodiment relating to the aspect of recommendations provided by the system, the system can track the subscriber's improvement or non-improvement in specific courses or curriculums, and based upon such data provided recommendations for, if improving very well, more challenging questions or skipping of certain levels of instruction, or alternatively, if the subscriber is not improving as desired, repeating certain questions or areas of instruction.

The above detailed description teaches certain preferred embodiments of the present inventive educational or instructional system and method using cellular media. While preferred embodiments of the cellular education system and method have been described and disclosed, it will be recognized by those skilled in the art that modifications and/or substitutions are possible and such modifications and substitutions are within the true scope and spirit of the present invention. It is likewise understood that the attached claims are intended to cover all such modifications and/or substitutions.

What is claimed is:

1. A method for providing educational and instructional programs to subscribers through said subscribers' cellular devices, comprising the steps of:
(a) selecting an instructional question to be transmitted to a subscriber's cellular device;
(b) transmitting the selected instructional question to the subscriber's cellular device;
(c) receiving from the subscriber's cellular device a response to the selected instructional question;
(d) determining whether the subscriber's response correctly answered the selected instructional question;
(e) analyzing the subscriber's response and providing feedback to the subscriber based upon said analysis of the subscriber's response.

2. The method of providing educational and instructional programs to subscribers through said subscribers' cellular devices, according to claim 1, wherein the instructional questions are for vocational training.

3. The method of providing educational and instructional programs to subscribers through said subscribers' cellular devices, according to claim 1, wherein the instructional questions are a true-false format.

4. The method of providing educational and instructional programs to subscribers through said subscribers' cellular devices, according to claim 1, wherein the instructional questions are a multiple choice format.

5. The method of providing educational and instructional programs to subscribers through said subscribers' cellular devices, according to claim 1, wherein the instructional questions are in a format requiring a short answer response.

6. A method for providing educational and instructional programs to subscribers through said subscribers' cellular devices, comprising the steps of:
(a) identifying a subscriber's cellular device for receipt of educational and instructional data;
(b) authorizing the subscriber's request for access to an instructional program;
(c) providing to the subscriber's cellular device a selection of instructional programs;
(d) providing to the subscriber's cellular device a selection of instructional levels;
(e) providing to the subscriber's cellular device a selection of instructional formats;
(f) receiving from the subscriber a selected instructional program, instructional level, and instructional format;
(g) selecting an instructional question based upon the selected instructional program, instructional level, and instructional format;
(h) transmitting the selected instructional question to the subscriber's cellular device;
(i) receiving from the subscriber's cellular device an answer to the selected instructional question;
(j) determining whether the subscriber's answer is a correct answer to the selected instructional question;
(k) providing feedback to the subscriber based upon the determination of whether the subscriber's answer was a correct answer; and
(l) recording the subscriber's answer to the selected instructional question in a database.

7. The method for providing educational and instructional programs to subscribers through said subscribers' cellular devices, according to claim 6, wherein the selection of instructional programs are high school level courses comprising English, foreign languages, mathematics, history, science, and humanities.

8. The method for providing educational and instructional programs to subscribers through said subscribers' cellular devices, according to claim 7, wherein the selection of instructional levels are high school grades comprising ninth, tenth, eleventh, and twelfth grade.

9. The method of providing educational and instructional programs to subscribers through said subscribers' cellular devices, according to claim 7, wherein the instructional questions are for vocational training.

10. The method for providing educational and instructional programs to subscribers through said subscribers' cellular devices, according to claim 6, wherein at least one of the selection of instructional formats includes a self-paced interaction between the subscriber and a computer processor.

11. The method for providing educational and instructional programs to subscribers through said subscribers' cellular devices, according to claim 6, wherein at least one of the selection of instructional formats includes real-time communication between the subscriber and an instructional tutor.

12. The method of providing educational and instructional programs to subscribers through said subscribers' cellular devices, according to claim 1, wherein the system further analyzes and recommends future instruction based upon the history of the subscribers' responses.

13. A system for providing educational and instructional curricula to subscribers using cellular communications, comprising:
one or more servers in communication with a global telecommunications network;
a database maintained within the one or more servers;
a plurality of subscribers' cellular devices in communication with the telecommunications network that is in communication with the one or more servers;
wherein the one or more servers operate a computer software program that sequences at least the following steps:
(a) selecting an instructional question from the database to be transmitted to a subscriber's cellular device;
(b) transmitting the selected instructional question over the global telecommunications network to one or more subscriber's cellular device;
(c) receiving from one or more of the subscriber's cellular device a response to the selected instructional question;
(d) determining whether the subscriber's response correctly answered the selected instructional question;
(e) analyzing the subscriber's response and providing feedback to the subscriber based upon said analysis of the subscriber's response.

14. A system for providing real-time interactive education to subscribers using cellular communications, comprising:
one or more servers in communication with a global telecommunications network;
a database maintained within the one or more servers;
a plurality of subscribers' cellular devices in communication with the telecommunications network that is in communication with the one or more servers;
wherein the one or more servers operate a computer software program that selects an instructional question from the database to be transmitted to a subscriber's cellular device; transmits the selected instructional question over the global telecommunications network to one or more subscriber's cellular device; receives an answer to the transmitted instructional question from one or more of the subscriber's cellular devices; determines whether the subscriber's response correctly answered the selected instructional question; and provides feedback to the subscriber based upon said determination whether the subscriber's response was correct.

15. A method for providing educational and instructional programs to subscribers through said subscribers' wireless devices, comprising the steps of:
(a) selecting an instructional question to be transmitted to a subscriber's wireless device;
(b) transmitting the selected instructional question to the subscriber's wireless device;
(c) receiving from the subscriber's wireless device a response to the selected instructional question;
(d) determining whether the subscriber's response correctly answered the selected instructional question;
(e) analyzing the subscriber's response and providing feedback to the subscriber based upon said analysis of the subscriber's response.

16. The method of providing educational and instructional programs to subscribers through said subscribers' wireless devices, according to claim 15 wherein the instructional questions are transmitted to the subscriber's wireless device by streaming video.
